(19) United States
(12) Patent Application Publication
(10) Pub. No.: US 2006/0185654 A1
(43) Pub. Date: Aug. 24, 2006

(54) Cost optimized electric EGR valve

(75) Inventors: Russell M. Modien, Chatham (CA); Mike Gauthier, Lake Orion, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/344,925

(22) Filed: Feb. 1, 2006

Related U.S. Application Data
(60) Provisional application No. 60/648,829, filed on Feb. 1, 2005.

(51) Int. Cl. F02M 25/07; F16K 31/02

(52) U.S. Cl. 123/568.21; 251/129.15

(57) ABSTRACT

An exhaust gas recirculation (EGR) valve includes an actuator mountable to a valve assembly such that a single actuator design can be utilized for different valve assemblies. The actuator is linked to the valve assembly through a calibration plug that provides for the calibration of an actuator armature position to a desired valve element position. The interface between the armature and valve element with the calibration plug provide adjustment and calibration to tailor operation of the actuator to a desired operation of the valve assembly.

### CROSS REFERENCE TO RELATED APPLICATION

The application claims priority to U.S. Provisional Application No. 60/648,829 which was filed on Feb. 1, 2005.

### BACKGROUND OF THE INVENTION

This invention generally relates to an exhaust gas recirculation (EGR) valve and actuator. More particularly, this invention relates to an EGR valve and actuator that utilizes a single actuator that is compatible with many different valves, and a method of assembling the EGR valve and actuator.

An electric exhaust gas recirculation valve utilizes a solenoid to power a valve controlling the flow of exhaust gases into an engine intake system. The general operation of a solenoid is known and includes the proportional movement of an armature in response to a generated magnetic field. The magnetic field is generated by a coil and directed through upper and lower stators to provide the desired magnetic force to move the armature. Movement of the armature is related to the current applied to the coil such that a specified applied current provides an expected movement of the armature, which in turn opens the valve a desired amount. For these reasons it is desired that each solenoid produced for a specific application perform in a defined and expected manner for a given current input. Such consistency between parts often requires expensive parts with tight tolerances.

Disadvantageously, the use of expensive parts increases costs of the overall valve assembly when cost reduction is a continuous goal for all automotive part suppliers and manufacturers. Further, performance requirements are also becoming more demanding in addition to the desire to reduce cost.

Accordingly, it is desirable to develop an EGR valve and actuator that utilizes easily produced parts and methods while maintaining desired performance control accuracy and durability.

### SUMMARY OF THE INVENTION

An example exhaust gas recirculation (EGR) valve according to this invention includes an actuator mountable to a valve assembly such that a single actuator design can be utilized for different valve assemblies. The actuator is linked to the valve assembly through a calibration plug. The calibration plug provides for the calibration of an actuator armature position to a desired valve element position.

The example valve assembly includes a valve housing that defines a first bore and a second bore. An inlet and outlet communicate with the second bore to define a path for exhaust gases. The flow of exhaust gases through the second bore is metered by a pintle. The pintle is guided within the second bore by a bearing and seals against a valve seat fabricated from a stamping.

The example pintle is attached to the calibration plug on a second end that extends through the bearing and into the first bore. The valve housing includes a top mating portion that includes a mounting surface to which the actuator is secured. The valve assembly can be modified to provide for application specific requirements without requiring redesign of the actuator as the top mating portion is maintained as a standard configuration while other regions of the valve housing are modified to provide application specific mating requirements.

The actuator and the housing assembly include two adjustable features to accommodate for manufacturing tolerances and adjust valve performance. First, an interface between the shaft and an armature and, second a press fit between a pintle and the calibration plug. Both of these adjustment features provide adjustment and calibration to tailor operation of the actuator to a desired operation of the valve assembly. The mating and calibration feature provided by the shaft mounted armature and calibration plug provide for the use of the actuator for many different valve housing configurations.

These and other features of the present invention can be best understood from the following specification and drawings, the following of which is a brief description.

### BRIEF DESCRIPTION OF THE DRAWINGS

FIG. 1 is a cross-sectional view of an example EGR valve and actuator according to this invention.

FIG. 2 is a cross-sectional view of an interface between the example actuator and the valve.

FIG. 3 is an exploded view of the example actuator.

FIG. 4 is a top plan view of an example stamping for a strap shell of the actuator.

FIG. 5 is a top plan view of the completed example strap shell.

FIG. 6 is an exploded view of the example valve.

FIG. 7 is a top plan view of an example spring retainer.

FIG. 8 is a cross-sectional view of another example valve housing according to this invention.

FIG. 9 is a cross-sectional view of another example valve housing according to this invention.

### DETAILED DESCRIPTION OF THE PREFERRED EMBODIMENT

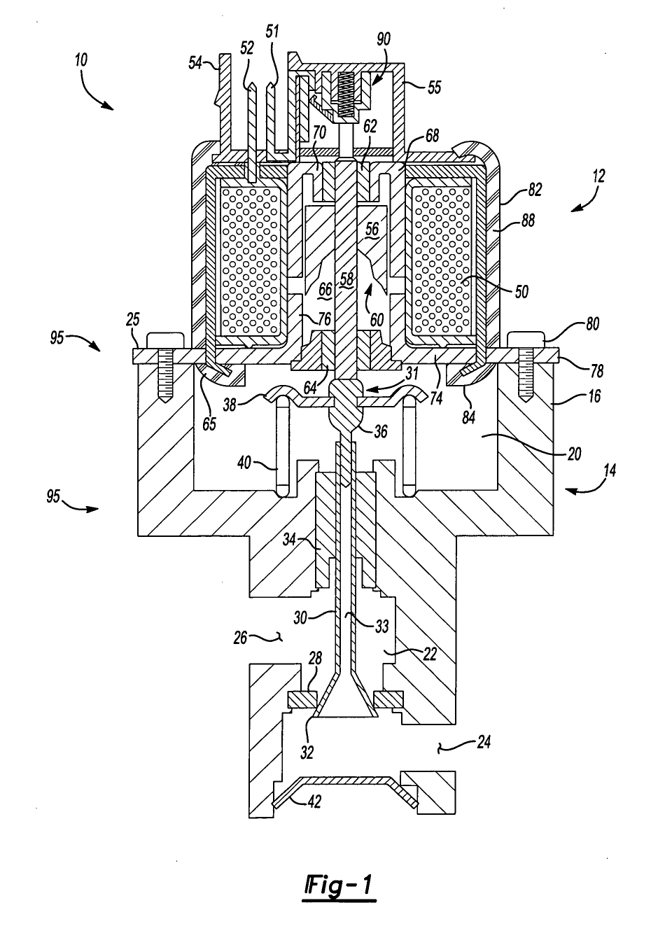

Referring to FIG. 1, an exhaust gas recirculation (EGR) valve 10 includes an actuator 12 mountable to a valve assembly 14 such that a single actuator design can be utilized for different valve assemblies. The actuator 12 controls movement of a pintle 30 through an interface with a calibration plug 36. The calibration plug 36 provides for the calibration of a relative position between the pintle 30 and an armature shaft 58 within the actuator 12. The calibration plug 36 is pressed to a desired depth within a bore 33 of the pintle 30. The armature shaft 58 abuts a dome 31 of the calibration plug 36 to control a position of the pintle 30.

The example valve assembly 14 includes a valve housing 16 that defines a first bore 20 and a second bore 22. An inlet 24 and outlet 26 communicate with the second bore 22 to define a path for exhaust gases. The flow of exhaust gases through the second bore 22 is metered by the pintle 30. The pintle 30 is guided within the second bore 22 by a bearing 34. The bearing 34 includes a thin wall to reduce material costs.

The pintle 30 includes a sealing head 32 that seals against a valve seat 28. The valve seat 28 is fabricated from a stamping and includes an opening that cooperates with the sealing head 32 of the pintle 30.

The example pintle 30 is attached to the calibration plug 36 and extends through the bearing 34 and into the first bore 20. The calibration plug 36 is attached to a spring retainer 38. The spring retainer 38 is a stamped part that includes features for retaining a spring 40. The spring 40 retains the pintle 30 in a normally closed position against the valve seat 28. The spring retainer 38 includes a circumferential indentation feature for receiving and retaining an end of the spring 40.

The valve housing 16 includes a top mating portion generally indicated at 95. This top mating portion 95 includes a mounting surface 25 to which the actuator 12 is secured and the first bore 20 that includes the calibration plug 36, spring 40 and spring retainer 38. The valve assembly 14 can be modified to provide for application specific requirements without requiring the redesign of the actuator 12. The top mating portion 95 is maintained as a standard configuration while other regions of the valve housing 16 are modified to provide application specific mating requirements.

The valve housing 16 includes an end plug 42 to seal the lower end of the second bore 22. The end plug 42 includes spring tab features that are biased outwardly against an interior surface of the valve housing 16. The outward bias of the end plug 42 provides the desired retention force to hold the end plug 42 within the valve housing 16.

The actuator 12 includes a coil assembly 50 defining a bore 66. An upper stator 68 and a lower stator 74 extend into the bore 66 to partially define a desired magnetic circuit. The upper stator 68 is spaced apart from the lower stator 74 providing a desired air gap. The air gap provides for movement to the armature 56 within the bore 66 responsive to the application of current to the coil assembly 50.

The coil assembly 50 includes terminals 52 that extend from the coil assembly 50 into a connector pocket 54. The connector pocket 54 provides for electrical communication with a controller (not shown) as is known.

The armature 56 is supported on the shaft 58. The shaft 58 in turn is guided by an upper bushing 62 and a lower bushing 64. The upper bushing 62 is pressed into a bore portion 70 of the upper stator 68. The lower bushing 64 is pressed into an outer bushing 65 which is in turn pressed into the bore portion 76 of the lower stator 74. Because the armature 56 is supported on the shaft 58, the bore 66 of the coil assembly 50 is not a bearing surface. Further, the bore 70 of the upper stator 68 and the bore 76 of the lower stator 74 are not bearing surfaces for the shaft 58. Because the armature 56 is supported on the shaft 58, there is no need for a non-magnetic sleeve to support sliding movement of the armature 56 within the coil assembly 50.

The armature 56 further includes a flux end 60 including features that provide desired magnetic flux characteristics. As the armature 56 includes the desired features for tailoring the magnetic flux characteristics with the lower stator 74, the configuration of the lower stator 74 can be greatly simplified.

The lower stator 74 also includes a mount plate 78 that cooperates with the mounting surface 25 of the valve housing 16 to attach the actuator 12 to the valve assembly 14. The mount plate 78 includes openings for fasteners 80 that engage the valve housing 16. The actuator 12 and the top most portion 95 of the valve housing 16 are common for the many possible valve configurations such that the actuator 12 can be utilized for many different valve housing configurations.

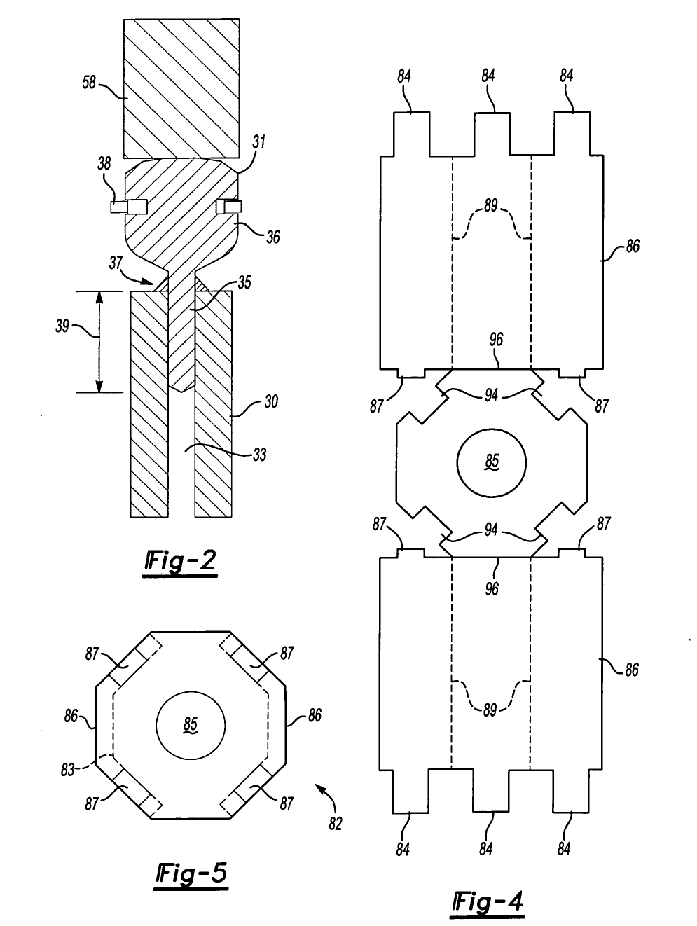

Referring to FIG. 2 with continuing reference to FIG. 1, the calibration plug 36 provides the interface between the actuator 12 and the valve assembly 14. The shaft 58 abuts a dome 31 of the calibration plug 36 and a pintle bore 33 receives a stem 35. The fit of the stem 35 within the pintle bore 33 of the and the pintle 30 is a light press fit to hold the desired position until a weld 37 or other permanent securing means can be performed. The calibration plug 36 is first pressed into the pintle 30 to a desired depth 39. The depth 39 is adjusted to provide the desired calibration with the actuator 12. The shaft 58 contacts the dome 31 of the calibration plug 36, but is not attached. The spring 40 maintains a biased contact between the shaft 58 and the come 31.

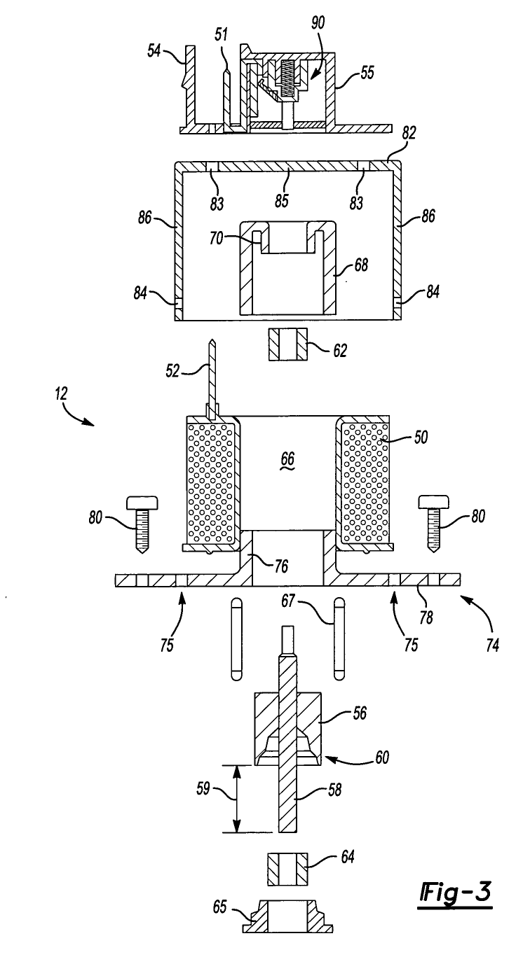

Referring to FIG. 3 with continuing reference to FIGS. 1 and 2, the actuator 12 is separately calibrated by adjusting a length 59 between an end of the shaft 58 and the armature 56. Operation of the actuator 12 is thereby tailored to provide different magnetic force requirements by adjusting the length 59. Further, the valve assembly 14 is calibrated by adjusting the depth 39 to tailor valve operation to desired conditions. The combined adjustments provide for actuator 12 and valve assembly 14 operation that can be tailored to meet application specific requirements.

Referring to FIGS. 3, 4 and 5, the actuator 12 is illustrated in an exploded view. Assembly of the actuator 12 begins by pressing the upper stator 68 into the strap shell 82. The strap shell 82 is a stamped part and includes an opening 85 into which the upper stator 68 is pressed. The opening 85 includes compliant features 83 that maintain magnetic contact between the strap shell 82 and the upper stator 68. The upper stator 68 is also a stamped part and includes the bore 70. Once the upper stator 68 is pressed into the strap shell 82, the coil 50 is slide onto the upper stator 68 such that the upper stator 68 extends into the bore 66 of the coil assembly 50.

Referring to FIGS. 4 and 5, the strap shell 82 includes fingers 86 that are bent to form a generally U-shape. The fingers 86 of the strap shell 82 create a substantially cylindrical shape around the coil assembly 50. The fingers 86 include two 45° bends 89 that form a portion of an octagon shape when the fingers 86 are bent 90° along bends 96. The strap shell 82 then generally forms an octagon shape with the two fold down fingers 86 that are also folded along the bends 89.

The fingers 86 are folded along the two 45° bends 89 to form three sections. The two outer most sections include tabs 87 near a top portion of the strap shell 82. The tabs 87 are received in slots 94 in the top section when the fingers 86 are folded along the bends 96. The three sections formed by the bends 89 each include a tab 84 that is received within slots 75 of the lower stator 74.

Referring back to FIG. 3, the lower stator 74 is then inserted into the coil assembly 50 with the tabs 84 extending through slots 75. The tabs 84 are then bent over to secure the lower stator 74 to the strap shell 82 and around the coil assembly 50. Once the lower stator 74 is secured to the strap shell 82, a sensor assembly 90 is assembled to the coil assembly 50. The sensor assembly 90 includes the housing 55 that defines the connector pocket 54. The connector pocket 54 includes an opening for the terminal 52 of the coil 50. Further, the connector pocket 54 includes the terminal 51 from the senor assembly 90. The sensor assembly 90 provides for the measurement and monitoring of a liner position of the shaft 58 and thereby the armature 56 within the coil assembly 50.

With the sensor assembly 90 attached, the entire assembly is overmolded with a settable mixture. The settable mixture encapsulates portions of the actuator assembly to protect components from the environment in which the actuator operates. Further, the overmold secures the sensor assembly 90 to the actuator 12. During the overmolding process the loosely toleranced components are held in tight alignment by features within the mold. There is built into the various components compliance at each interface to accommodate the molding pressures encountered while maintaining required relationships to provide the desired magnetic flux characteristics. The settable material provides an effective barrier to the elements without using special coatings or seals.

Once the assembly is overmolded, the upper and lower bushings 62, 64 are installed. The upper and lower bushings 62, 64 are Teflon lined to reduce friction resisting movement of the shaft 58. The Teflon lined bushings 62, 64 also provide for alignment of the shaft 58 and thereby the armature 56 within the coil assembly 50. The lower bushing 64 is first assembled to an outer bushing 65 that is then pressed into the bore portion 76 of the lower stator 74 after the armature 56 and shaft 58 are inserted into the bore 66.

The shaft mounted armature 56 eliminates the need for a low friction coating or non-magnetic sleeve within the bore 66. The distance 59 of the armature 56 relative to an end of the shaft 58 is determined to provide desired magnetic properties. With the armature 56 assembled within the bore 66, the lower bushing 64 is pressed into the bore 76. The actuator 12 is essentially complete and ready for installation to the valve housing 16. The actuator 12 may also include an additional spring 67 to maintain a desired armature position during high vibration conditions. The additional spring 67 can be placed between the armature and the upper stator 68 or in other locations determined to provide the desired vibration dampening performance. Further, although a standard spring 67 is schematically illustrated, other known biasing members, such as Belleville washers for example are also within the contemplation of this invention.

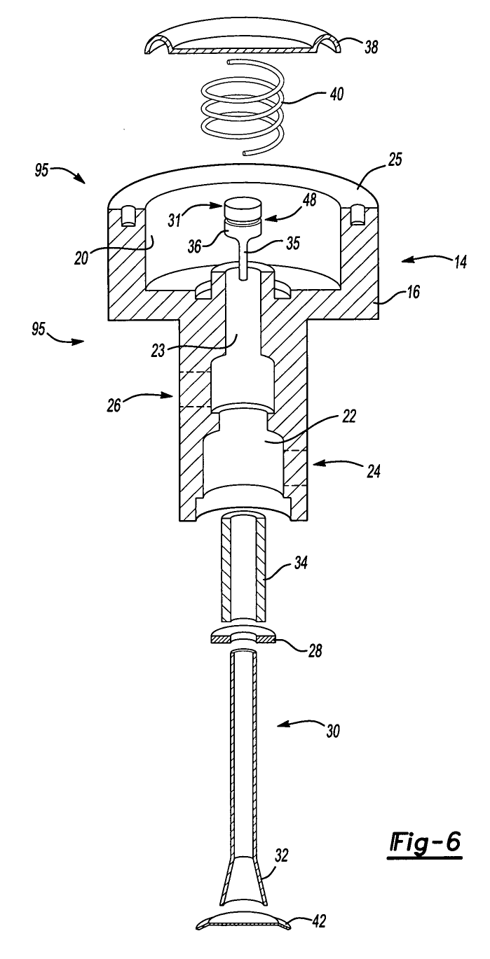

Referring to FIGS. 6 and 7, the valve assembly 14 is shown in an exploded view with the valve housing 16 including the common top portion 95 that provides the mating surface for the actuator 12. The valve assembly 14 is assembled by pressing a bearing 34 into a 23 bore between bores 20 and 22. The bearing 34 guides the pintle 30, and includes a relatively thin wall to reduce material. The bearing 34 is fabricated from a material determined to provide the desired low friction resistance to pintle movement along with desired durability properties. As the expense of the bearing 34 is generally determined by the material volume or weight, the reduced or thin walled bearing 34 reduces expense by reducing the overall amount of material volume utilized.

The valve seat 28 is then pressed into the valve housing 16. The valve seat 28 is a stamped part including an opening for the pintle head 32. The valve seat 28 is pressed in and then staked to maintain the desired position and prevent shifting.

With the bearing 34 and valve seat assembled into the valve housing 16, the pintle 30 is inserted into the valve housing 16 and the calibration plug 36 is attached to the pintle 30 (FIG. 2). The stem 35 is received within the pintle bore 33 and held by a light press fit provided by appropriately toleranced components. The light press fit provides for a desired fit and hold prior to a more permanent attachment and securing means such as the weld 37.

The calibration plug 36 includes a circumferential groove 48 that fits into a key slot 46 defined in the spring retainer 38. The spring retainer 38 is a stamped part including a circumferential indentation to hold an end of the spring 40. The circumferential groove 48 fits into the key slot 46 to connect the calibration plug 36 to the spring retainer 38. The spring retainer 38 is held in position by a detent 45 that the calibration plug 36 rests in. The spring 40 is assembled between the spring retainer 38 and the valve housing 16 to provide a biasing force on the pintle 30.

In the example housing 16 the outlet 26 is disposed on a side, therefore the end plug 42 is inserted into the end of the valve housing 16. The end plug 42 is stamped part that is configured to exert an outwardly directed tension on the inner surface of the valve housing 16. The outward tension holds the end plug 42 in place and eliminates the requirement for secondary operations to secure the end plug 42 to the valve housing 16. The actuator 12 is then mounted to the valve housing 16 such that the shaft 58 abuts the dome 31 of the calibration plug 36.

The actuator 12 and the valve assembly 14 include two adjustable features to accommodate and account for manufacturing tolerances. The press fit of the stem 35 into the pintle 30 and the press fit of the armature 56 onto the shaft 58. The two adjustment features provide adjustment and calibration to tailor operation of the actuator 12 the valve assembly 14. The shaft mounted armature 56 provides for the tailoring and adjustment of the magnetic characteristics of the actuator 12 to maintain a desired output related to the desired current input. The abutting interface between the shaft 58 and the calibration plug 36 provides for the use of the actuator 12 with many different valve housing configurations.

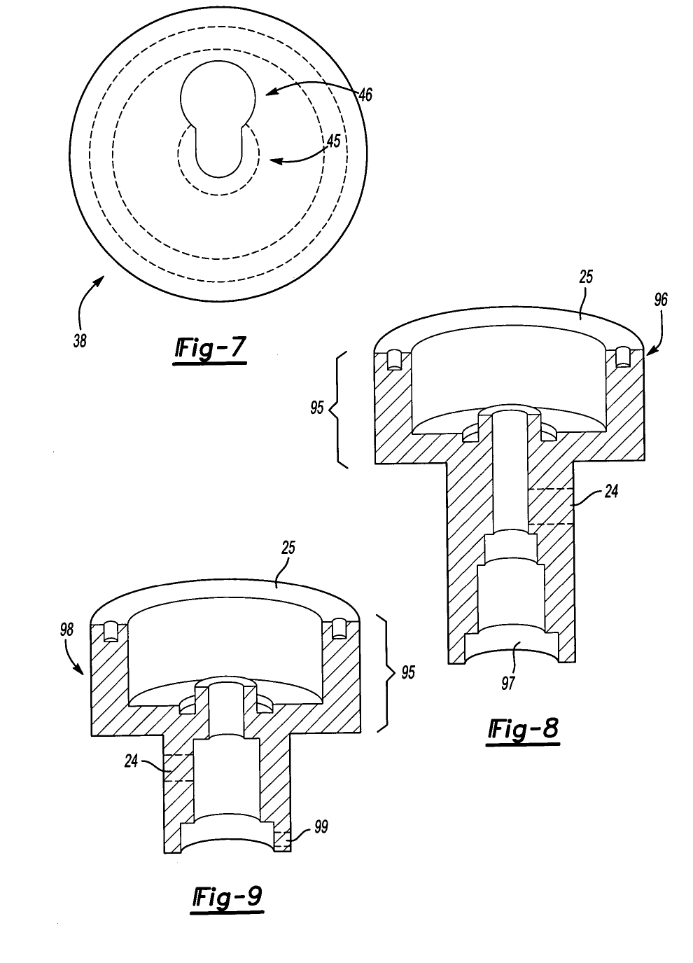

Referring to FIGS. 8 and 9, alternate example valve housings 96, 98 are shown that include different lower features. Each of the valve housings 96, 98 include the common top most portion 95 and mounting surface 25 that correspond with the actuator 12. Accordingly, the actuator 12 can be utilized and adjusted to accommodate many different valve housing configurations to provide a common part for many different applications.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An emission control valve assembly for controlling the flow of exhaust gases comprising:
a valve housing defining a flow path for exhaust gases;
a valve element movable within the valve housing for controlling the flow of exhaust gases through the valve housing;
a calibration plug attached to the valve element; and
an actuator for selectively driving the valve element including an armature attached to the calibration plug.

2. The assembly as recited in claim 1, wherein a connection between the calibration plug and the valve element is adjustable for calibrating a desired relationship between armature position and valve element position.

3. The assembly as recited in claim 1, including a spring retainer attached to the calibration plug for retaining a spring biasing the valve element toward a desired position.

4. The assembly as recited in claim 3, wherein the spring retainer includes a key hole receiving the calibration plug.

5. The assembly as recited in claim 1, wherein the valve housing comprises a bore having an inlet and an outlet and a valve seat disposed within the bore between the inlet and outlet that corresponds with the valve element, wherein the bore includes an open end through which at least the valve seat is assembled and an end plug for closing the open end.

6. The assembly as recited in claim 5, wherein the end plug exerts a spring tension against the bore.

7. The assembly as recited in claim 1, wherein the armature is supported on a shaft movable within the actuator.

8. The assembly as recited in claim 7, wherein a linear position of the armature on the shaft is adjustable for calibrating a desired magnetic characteristic.

9. The assembly as recited in claim 1, wherein the actuator includes a coil assembly defining a bore within which the armature moves.

10. The assembly as recited in claim 9, including an upper stator and a lower stator defining a portion of a magnetic flux path, wherein each of the upper stator and the lower stator include a portion extending into the bore of the coil.

11. The assembly as recited in claim 10 including an outer shell comprising a shell comprising a top portion mounted on a top surface of the actuator, and at least two fingers extending downwardly surrounding the coil, wherein each of the at least two fingers includes a tab to secure the shell to the coil.

12. The assembly as recited in claim 1, wherein the actuator is at least partially overmolded with a settable material.

13. The assembly as recited in claim 1, wherein the actuator is mounted to the valve housing.

14. The assembly as recited in claim 13, wherein said actuator comprises a modular assembly mountable to valve housings of differing configurations.

15. The assembly as recited in claim 1, including a sensor assembly for measuring a position of the armature within the actuator.

16. A method of assembling an exhaust gas recirculation device comprising the steps of:
a) defining a gas flow path through a valve housing;
b) supporting a valve element within the valve housing;
c) attaching an actuator to the valve housing; and
d) positioning an armature of the actuator relative to the valve element in a desired relative orientation to calibrate operation of the valve element with operation of the actuator.

17. The method as recited in claim 16, wherein step d further includes pressing a stem of the calibration plug into the valve element.

18. The method as recited in claim 17 including assembling a spring retainer to the calibration plug and assembling a spring to bias the valve element toward a desired position.

19. The method as recited in claim 16, including the step of assembling the armature onto a shaft disposed within the actuator and positioning the armature on the shaft to provide a desired magnetic characteristic of the armature.

20. The method as recited in claim 16, including the step of assembling a sensor within the actuator for measuring a position of the armature.

21. The method as recited in claim 16, including the step of fabricating the actuator including the steps of installing an upper stator and a lower stator into a coil assembly and wrapping a flux strap around the coil assembly to define a magnetic circuit.

22. The method as recited in claim 21, wherein the step of wrapping the flux strap around the coil assembly includes bending a first and second strap from a first surface around the coil assembly to a second surface and bending a tab disposed on each of the first and second straps onto the second surface.

23. The method as recited in claim 22, including the step of overmolding the actuator.
